(19) United States
(12) Patent Application Publication
(10) Pub. No.: US 2008/0271270 A1
(43) Pub. Date: Nov. 6, 2008

(54) PROBE CLEANING TUBE

(75) Inventors: Yukihiko SAWADA, Yoshikawa (JP); Akiko MIZUNUMA, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS MEDICAL SYSTEMS CORP., Tokyo (JP)

(21) Appl. No.: 12/104,955

(22) Filed: Apr. 17, 2008

(30) Foreign Application Priority Data
May 1, 2007 (JP) 2007-120834

(51) Int. Cl. B08B 13/00

(52) U.S. Cl. 15/1

(57) ABSTRACT

A probe cleaning tube cleans a probe in a cleaning tub of an endoscope reprocessor having a water supply nozzle for supplying liquid for reprocessing, and is made of at least a soft resin tube. An aperture is made in a side of the soft resin tube, and has a diameter larger than an outer diameter of the probe. A removable water supply nozzle attachment is provided at one end of the soft resin tube for coupling to the water supply nozzle. A drain unit has a drain port at another end of the soft resin tube to stop passage of the probe.

### CROSS REFERENCE TO RELATED APPLICATION

This application is based on and claims the benefit of priority from the prior Japanese Patent Application No. 2007-120834 filed in Japan on May 1, 2007, the entire contents of which are incorporated by this reference.

### BACKGROUND OF THE INVENTION

1. Field of the Invention

The present invention relates to cleaning an Ultrasound probe.

2. Description of the Related Art

There are various ultrasound probes such as a probe with a guide wire port, a probe with a balloon, etc. An ultrasound probe with a guide wire port has a guide wire port to pass through a guide wire at the distal end, and the guide wire can conduct the ultrasound probe to the portion to be observed.

An endoscope to be used for inspections and treatment should be properly cleaned and high-level disinfected not only its outer surface but also all channels including auxiliary water and elevator wire channels, because it may comes in contact with mucous membranes directly or indirectly.

When using an endoscope reprocessor, the precleaned endoscope is placed in a cleaning tub. Then, to clean and disinfect the insides of the channels of the endoscope, connect the proper connecting tube to supply a fluid such as a liquid, a gas, etc. into the channels

The lid of the cleaning tub is closed and a predetermined service is pressed to start a cleaning and disinfecting step. First, a cleaning step is started and then a disinfecting step is started. In the cleaning step, a detergent solution is supplied to the cleaning tub to start a cleaning process. The outer surface of the endoscope is cleaned by the flow of the detergent solution. Each of the channels of the endoscope is cleaned by passing the detergent solution to the cleaning tub at the optimum flow rate. After the cleaning process, the detergent solution is drained and the cleaning tub and each of the channels of the endoscope are rinsed with water.

Next, control is passed to the disinfecting step, and the disinfectant solution is supplied to the cleaning tub. Then, the disinfectant solution is further supplied to the channels of the endoscope at the optimum flow rate. After the disinfectant solution is filled in the channels of the endoscope, the endoscope is soaked in the disinfectant solution for some time to complete the disinfecting process. After the disinfecting step, the disinfectant solution is drained with rinsing water, and then the endoscope is dried, thereby terminating the series of steps.

Thus, each time the endoscope is used, it is necessary to perform the above-mentioned cleaning and disinfecting steps (reprocessing procedure). Therefore, the endoscope reprocessor has become widespread to improve the efficiency of the operation and protect the health of the person in charge of the reprocessing procedure against the toxicity of the disinfectant solution.

The endoscope reprocessor has an ultrasonic cleaning function to correctly clean and disinfect the complicated and non-smooth shape of the endoscope. Relating to the ultrasound probe, there is a need to clean it by the endoscope reprocessor as with the endoscope.

Besides ultrasound probe, there are several kinds of prove which may be inserted into the endoscope instrument channel e.g. Position detecting probe, endo-therapy accessories.

An invention relating to the cleaning of the endo-therapy accessories for an endoscope is disclosed by the Japanese Published Patent Application No. 2001-258902.

### SUMMARY OF THE INVENTION

A probe cleaning tube to be used with an endoscope reprocessor having a water supply port for supplying a detergent solution to the cleaning tub according to the present invention.

The probe cleaning tube is made of at least a soft resin tube, and includes:

an aperture made in a side of the soft resin tube, and having a diameter larger than an outer diameter of the endoscope probe;

a removable water supply nozzle attachment provided at one end of the soft resin tube for coupling to the water supply nozzle; and

a drain unit having a drain port at another end of the soft resin tube to stop passage of the probe.

A probe cleaning tube cleans a probe in a cleaning tub of an endoscope reprocessor having a water supply port for supplying a detergent solution to the cleaning tub according to the present invention.

The probe cleaning tube is made of at least a plurality of soft resin tube and one or more joints having three or more outlets, and one end of the first soft resin tube is coupled to a first outlet of the joint, and the probe cleaning tube includes:

a drain unit having a drain port at another end of the soft resin tube to stop passage of the probe;

the probe configured to be inserted toward the drain unit of the first soft resin tube from a second outlet corresponding to the first outlet in the joint outlets; and

a removable water supply nozzle attachment for coupling to the water supply nozzle at a distal end of a second soft resin tube to which a third outlet of the joint is coupled.

### BRIEF DESCRIPTION OF THE DRAWINGS

FIG. 1 is a perspective view of the appearance of an endoscope reprocessor 1;

FIG. 2 shows the entire ultrasound probe cleaning tube according to the first mode for embodying the invention;

FIG. 3 shows the state of cleaning an ultrasound probe 20 using an ultrasound probe cleaning tube 10 according to the first mode for embodying the invention;

FIG. 4 is an enlarged view of the distal end of the ultrasound probe cleaning tube 10 when the ultrasound probe is cleaned;

FIG. 5 shows an example (1) of the sectional view of the distal end structure of the ultrasound probe cleaning tube 10 according to the first mode for embodying the invention;

FIG. 6 shows an example (2) of the sectional view of the distal end structure of the ultrasound probe cleaning tube 10 according to the first mode for embodying the invention;

FIG. 7 shows an example (3) of the sectional view of the distal end structure of the ultrasound probe cleaning tube 10 according to the first mode for embodying the invention;

FIG. 8 is a sectional view of the probe cleaning tube according to the second mode for embodying the invention;

FIG. 9 shows the state of providing a plurality of probe cleaning tubes for one water supply nozzle attachment according to the first embodiment of the third mode for embodying the invention;

FIG. 10 shows the state of providing a plurality of probe cleaning tubes for one water supply nozzle attachment according to the second embodiment of the third mode for embodying the invention.

### DESCRIPTION OF THE PREFERRED EMBODIMENTS

### First Mode for Embodying the Invention

When an ultrasound probe is cleaned by an endoscope reprocessor, there is the possibility that an ultrasound transducer is destroyed based on the sound field of an ultrasonic cleaning function of the endoscope reprocessor. As described above, an ultrasound transducer is mounted at the distal end of the ultrasound probe. The ultrasound transducer has a structure in which it is easily oscillated at a specific frequency to transmit and receive an ultrasound by means of oscillation. On the other hand, relating to the endoscope reprocessor, the state of the sound field in the cleaning tub by the ultrasonic cleaning function depends on the method of placing the endoscope to be cleaned. Therefore, depending on the state of the sound field, the ultrasound transducer can be destroyed by the standing wave resonating with the ultrasound transducer provided at the distal end of the ultrasound probe.

In addition, the cleaning and disinfecting procedure can be unsatisfactory due to the microstructures of the ultrasound probe. In the case of the ultrasound probe having microstructures such as a guide wire port, there is the possibility that the detergent solution or chemical agents cannot completely reach the microstructures in the cleaning tub of the endoscope reprocessor although the probe can be arranged in the cleaning tub of the endoscope reprocessor. For example, when bubbles enter the guide wire port, the detergent solution may not be able to satisfactorily enter the guide wire port. Therefore, the microstructures are manually cleaned and disinfected at present.

Thus, the modes for embodying the invention provides an ultrasound probe cleaning tube for improving the cleaning effect on the microstructures around the distal end of the ultrasound probe without destroying the function of the ultrasound transducer when the ultrasound probe is cleaned.

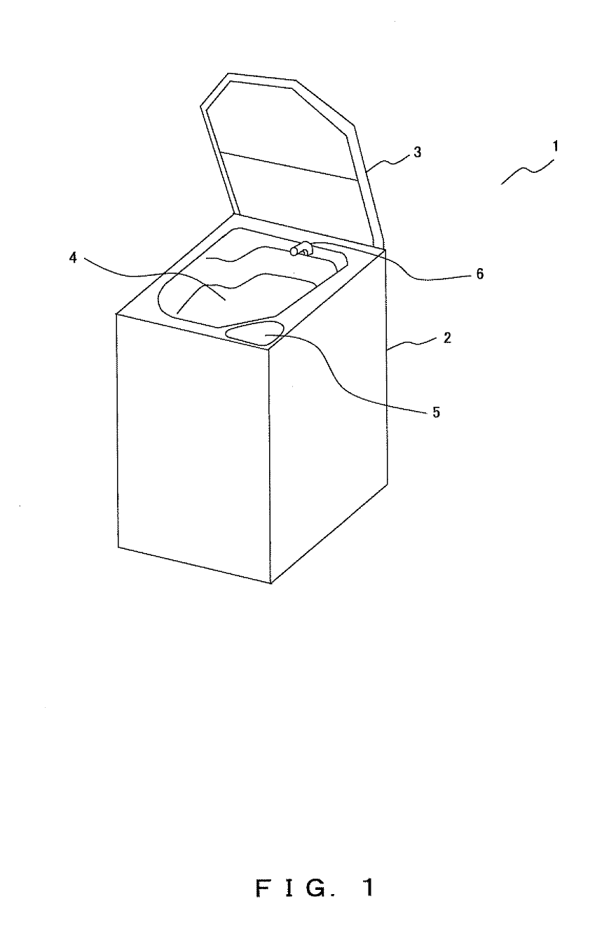

FIG. 1 is a perspective view of the endoscope reprocessor 1. A lid 3 is provided on the upper portion of a body 2 of the endoscope reprocessor 1. On the upper surface of the body 2, there are a cleaning tub 4 whose endoscope inlet is open upward and opened and closed by the lid 3, and an operation panel 5.

The operation panel 5 has setting switches such as a cleaning and disinfecting operation start switch, a cleaning and disinfecting mode selection switch, etc.

The cleaning tub 4 can store a used endoscope. A water supply nozzle 6 for supplying a fluid such as a detergent solution, a disinfectant solution, etc. is provided on the perimeter of the aperture of the cleaning tub 4. Furthermore, other components including a drain port, a circulation port, etc. (not shown in the attached drawings) are provided in the cleaning tub 4.

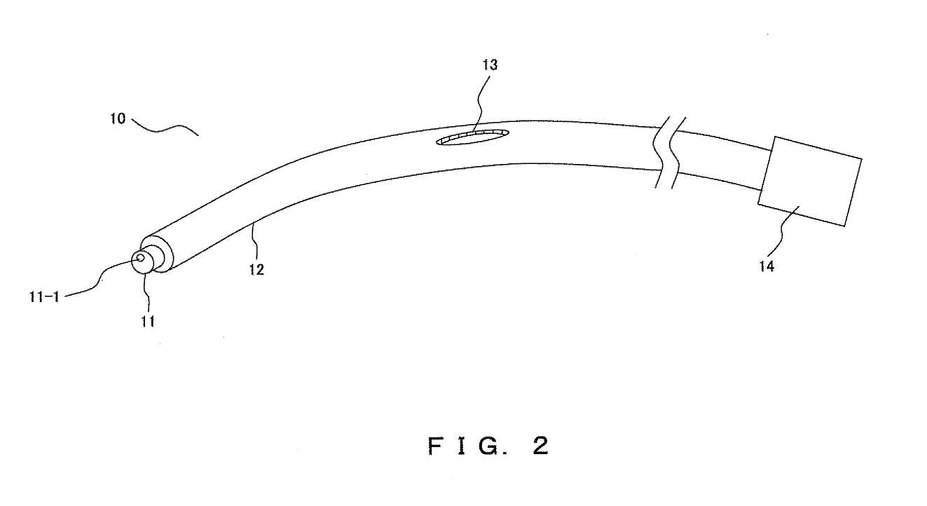

FIG. 2, shows the entire ultrasound probe cleaning tube according to the present mode for embodying the invention. The ultrasound probe cleaning tube 10 is configured by a resin tube 12, a draining member 11, and a water supply nozzle attachment 14.

The water supply nozzle attachment 14 for connection and fixture to the water supply nozzle 6 is provided at one end of the resin tube 12. The draining member 11 is provided at the other end (distal end) of the long resin tube 12. A drain port 11-1 is provided for the draining member 11, and the diameter of the drain port 11-1 is smaller than the diameter of the ultrasound probe. The water passing into the resin tube 12 is drained from the drain port 11-1. On the side of the resin tube 12, there is an aperture (probe insertion inlet) 13 for insertion of the ultrasound probe.

The draining member 11, the resin tube 12, and the water supply nozzle attachment 14 are configured by soft materials (for example, a silicon tube of a medical grade, a vinyl chloride of a medical grade, etc.) that are resistant to a detergent solution and a disinfectant solution, and do not emit environmental hormones or other toxic substance. Since the ultrasound probe cleaning tube 10 enters the cleaning tub 4 together with an ultrasound probe, it is necessary to configure the ultrasound probe cleaning tube 10 by a soft material not to damage the probe.

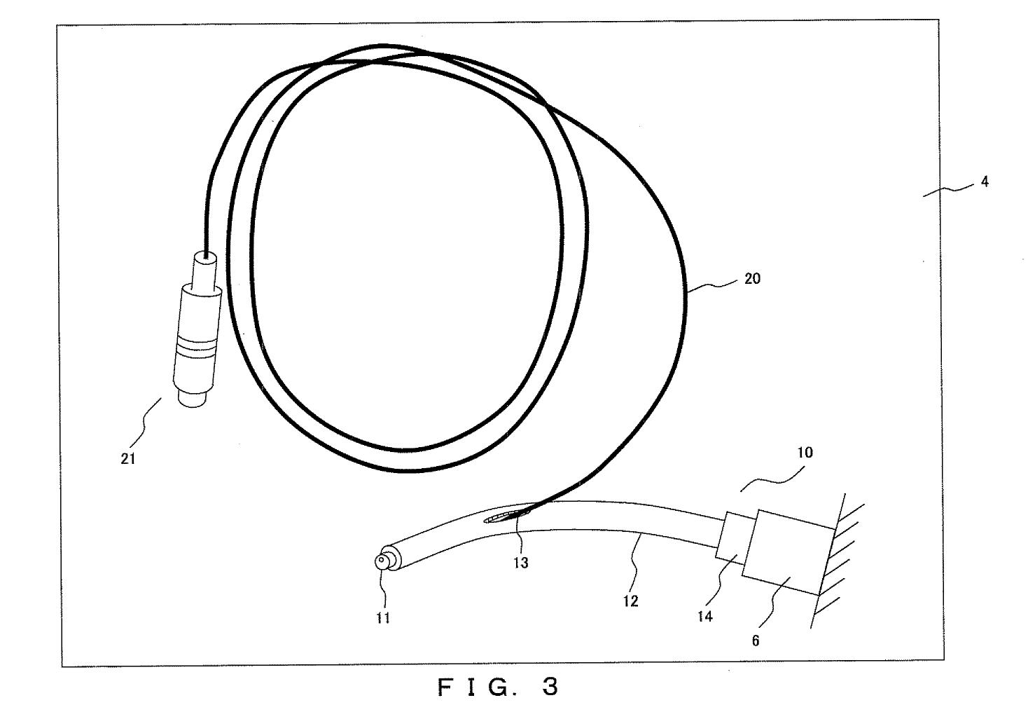

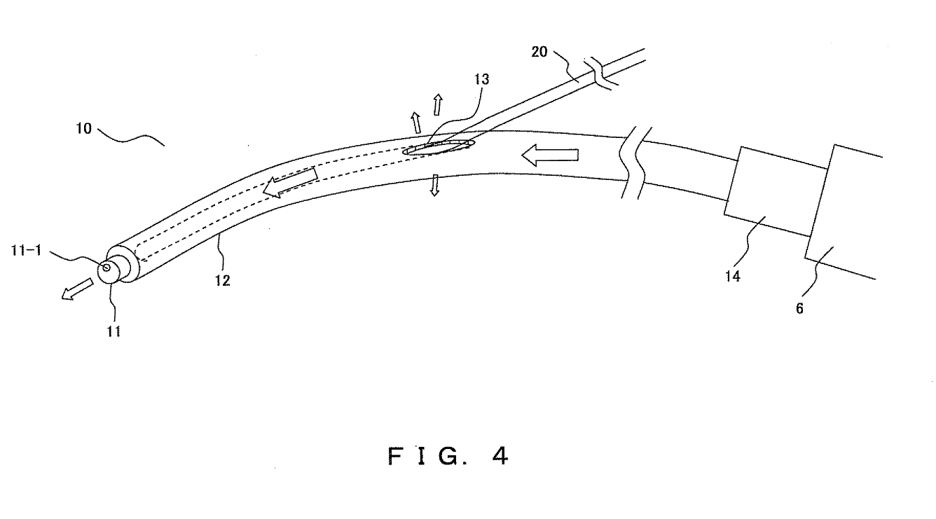

FIG. 3 shows the state of cleaning the ultrasound probe 20 using the ultrasound probe cleaning tube 10 according to the present mode for embodying the invention. FIG. 4 is an enlarged view of the distal end of the ultrasound probe cleaning tube 10 when the ultrasound probe is cleaned.

First, the water supply nozzle attachment 14 of the ultrasound probe cleaning tube 10 is connected and fixed to the water supply nozzle 6. The ultrasound probe 20 is inserted into the resin tube 12 from the probe insertion inlet 13 in the direction of the distal end of the resin tube 12.

Then, water is supplied from the water supply/curulation nozzle (not shown in the attached drawings). At this time, the entire ultrasound probe 20 is immersed in the cleaning tub 4. A waterproof cap is attached to a connector 21 (not shown in the attached drawings).

Thus, the water supplied from the water supply nozzle 6 of the endoscope reprocessor to the ultrasound probe cleaning tube flows in the direction of the distal end of the resin tube 12 along the side of the ultrasound probe 20 inserted into the resin tube 12 in the direction of the arrow, and is drained from the drain port 11-1.

In addition, a part of the water supplied from the water supply nozzle 6 of the endoscope reprocessor 1 is leaked around the probe insertion inlet 13 in its way to the distal end. The ultrasound probe 20 sways by the flow of the leaking water, thereby allowing the entire probe to correctly touch chemical agents.

It is necessary to design a configuration in which the water circulating in the resin tube 12 is drained from the distal end of the resin tube 12, and the distal end of the ultrasound probe 20 does not get out of the drain port, but stays in the resin tube 12.

Described below are the variations of the structures in which only water is drained from the distal end of the resin tube 12 and the distal end of the ultrasound probe 20 does not get out of the drain port.

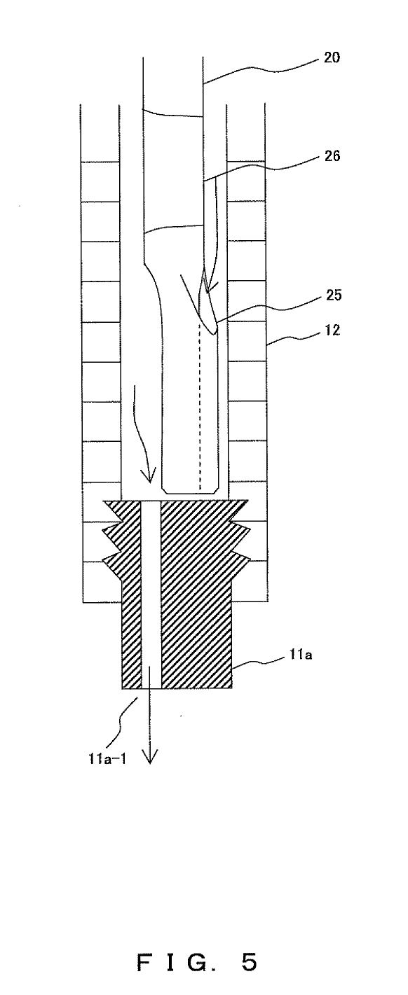

FIG. 5 shows an example (1) of the section of the structure of the distal end of the ultrasound probe cleaning tube 10 according to the present mode for embodying the invention. A guide wire port 25 is provided at the distal end of the ultrasound probe 20. Then, an ultrasound transducer 26 is provided at the rear of the guide wire port 25.

The distal end of the resin tube 12 is provided with a stopper by a draining member 11a having a drain port 11a-1. The surface of the draining member 11a contacting with the resin tube 12 is serrated so that the member cannot to be easily pulled out of the resin tube 12. The inner diameter of the resin tube can be designed to allow the ultrasound probe to be inserted into the tubes and allow water to pass around the ultrasound probe in the longitudinal direction of the ultrasound probe.

Since the drain port 11a-1 passes through the draining member 11a, the water that has passed the resin tube 12 is drained from the drain port 11a-1. The size of the diameter of the drain port 11a-1 is designed smaller than the diameter of the distal end of the ultrasound probe 20. Therefore, the distal end of the ultrasound probe 20 does not get out of the drain port 11a-1. In addition, on the section in the direction of the short side of the resin tube 12, the position of the drain port 11a-1 is displaced from the center of the inner diameter of the resin tube 12. Thus, the drain port 11a-1 is not blocked by the distal end of the ultrasound probe 20.

Since there arises the flow of water along the probe around the ultrasound probe and arises the flow of water through the guide wire port, the inner side of the guide wire port is cleaned.

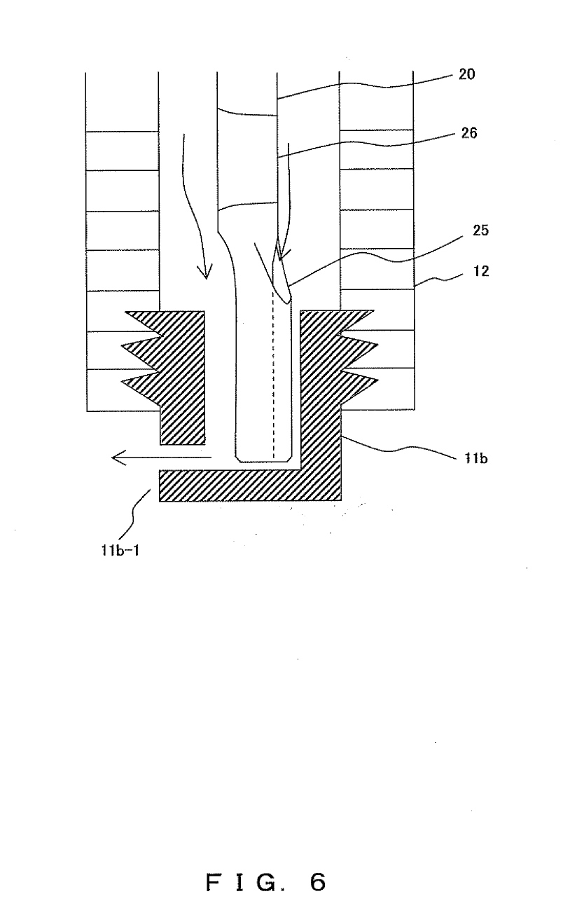

FIG. 6 shows an example (2) of the section of the structure of the distal end of the ultrasound probe cleaning tube 10 according to the present mode for embodying the invention. In the present mode, a hole is made in one side of the draining member 11 not to make a hole through the bottom of the draining member 11, and the horizontal hole (drain port 11b-1) is made from the side of a bottom 110 to the outside.

In FIG. 6, the inner diameter of the draining member 11 is larger than the diameter of the distal end of the ultrasound probe cleaning tube 10 so that the distal end of the ultrasound probe cleaning tube 10 can reach the bottom 110.

In the present embodiment, since a drain port 11ab-1 vertically penetrates in the direction of the axis of the ultrasound probe cleaning tube 10, the drain port 11b-1 is not blocked by the distal end of the ultrasound probe 20 although the position and the size of the drain port are not restricted as shown in FIG. 5.

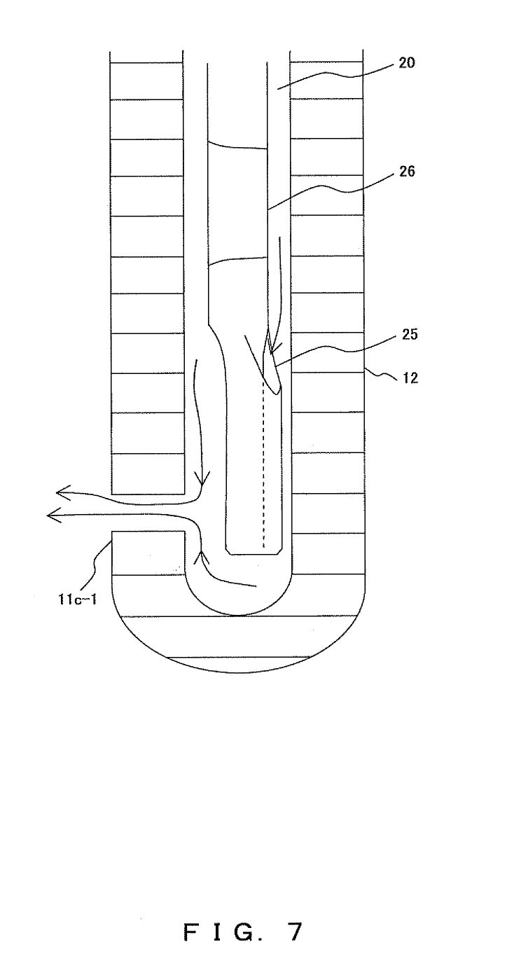

FIG. 7 shows an example (3) of the section of the structure of the distal end of the ultrasound probe cleaning tube 10 according to the present mode for embodying the invention. In FIG. 7, the draining member 11 is not provided, the end of the resin tube 12 is closed, and a horizontal through hole (drain port 11c-1) is provided near the closed distal end. Thus, it is not necessary to use the draining member 11, thereby reducing the total number of parts.

According to the present mode, the transducer at the distal end of the probe is protected by the resin tube, and the resin tube can prevent an accidental damage by a standing wave that attenuates the energy of the ultrasonic cleaning. Since the structure of the surface of the ultrasound probe is simpler than the structure of the endoscope, there arises no bad influence on the effect of the cleaning although the energy of the ultrasonic cleaning attenuates.

In addition, since there occurs the flow of water along the probe around the ultrasound probe, complicated portions such as a guide wire port etc. can be correctly cleaned.

Additionally, since only the attachment to the water supply nozzle of an existing endoscope reprocessor is required, it is not necessary to change the specification of the endoscope reprocessor. In addition, since a plurality of ultrasound probe can be cleaned when the endoscope reprocessor has plurality of water supply nozzle, the throughput of the reprocessing can be furthermore improved.

### Second Mode for Embodying the Invention

In the first embodiment, the probe insertion inlet 13 is provided in the side of the resin tube 12, and the ultrasound probe is inserted into the resin tube from the probe insertion inlet 13. In the present mode, the probe insertion inlet 13 is not provided in the side of the resin tube 12, but the ultrasound probe is inserted into the resin tube.

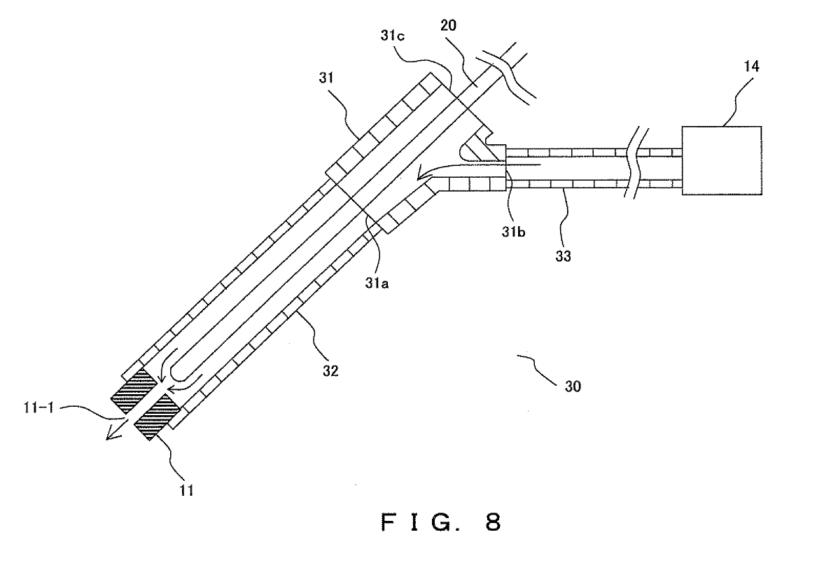

FIG. 8 is a sectional view of the ultrasound probe cleaning tube according to the present mode for embodying the invention. An ultrasound probe cleaning tube 30 shown in FIG. 8 is a combination of a resin tube 32 and a resin tube 33 by a tridental (tilt T-shaped) joint 31. The draining member 11 is provided at the distal end of the resin tube 32 connected to an aperture 31a of the joint 31. The distal end of the resin tube 33 connected to an aperture 31b of the joint 31 is provided with the water supply nozzle attachment 14. Since the distal end of the resin tube 32 is the same as in the first mode for embodying the invention, the description is omitted here.

First, the water supply nozzle attachment 14 of the ultrasound probe cleaning tube 30 is connected and fixed to the water supply nozzle 6. The ultrasound probe 20 is inserted into the resin tube 32 from an aperture 31c of the joint 31 in the direction of the distal end of the resin tube 32.

Then, water is supplied from the water supply nozzle 6. Then, the water flows through the resin tube 33, reaches the joint 31, and then passes to the resin tube 32. When the water enters the resin tube 32, it flows in the direction of the distal end of the resin tube 32 along the side of the ultrasound probe 20 inserted into the resin tube 32, and is then discharged from the drain port 11-1.

A part of the water entering the joint 31 is leaked from the aperture 31c of the joint 31, but the ultrasound probe 20 sways by the flow of the leaking wager, thereby allowing the entire probe to correctly touch a chemical agent.

According to the present mode, it is not necessary to provide a hole for insertion of the ultrasound probe into the resin tube as in the first mode for embodying the invention by using a tridental joint.

### Third Mode for Embodying the Invention

According to the present mode for embodying the invention, a plurality of ultrasound probe cleaning tubes are connected to one water supply nozzle attachment.

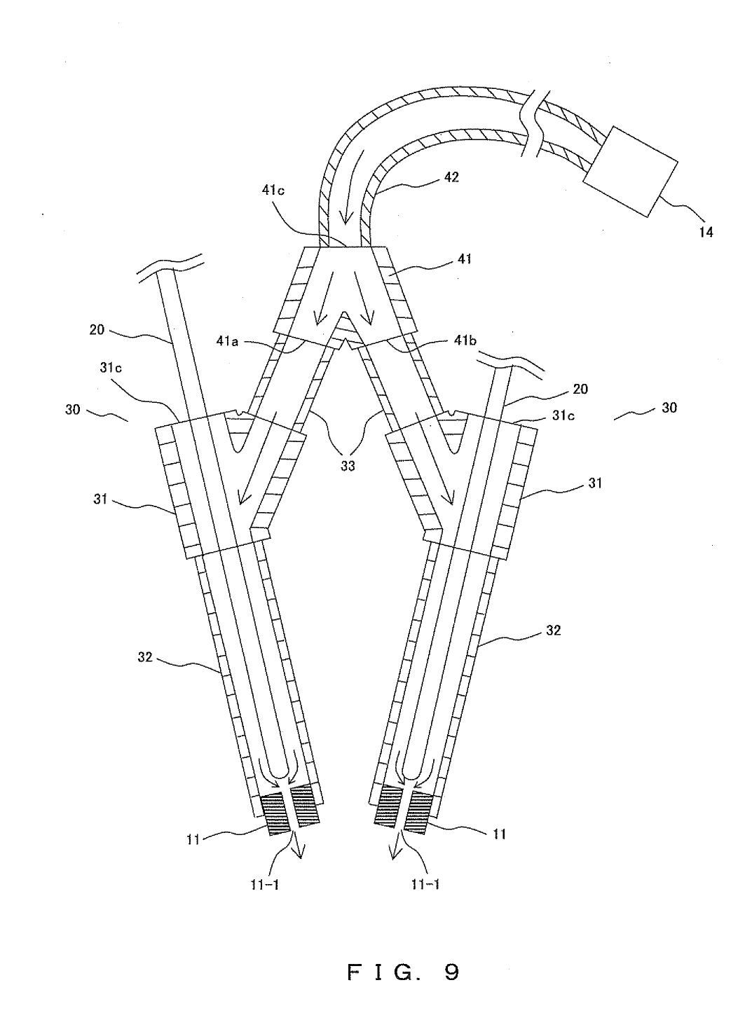

FIG. 9 shows the state of providing a plurality of ultrasound probe cleaning tubes for one water supply nozzle attachment according to the first embodiment of the present mode for embodying the invention. In the present mode, an ultrasound probe cleaning tube is provided with a plurality of ultrasound probe cleaning tubes 30 shown in FIG. 8 by using a joint having a plurality of inlets.

As shown in FIG. 9, the resin tube 33 is connected to each of two apertures 41a and 41b of tridental joint 41, and the ultrasound probe cleaning tube 30 shown in FIG. 8 is provided for each resin tube 33. The resin tube 42 is connected to an aperture 41c of the joint 41, and the water supply nozzle attachment 14 is attached at the distal end of the resin tube 42.

First, the water supply nozzle attachment 14 is connected and fixed to the water supply nozzle 6. In each of the ultrasound probe cleaning tubes 30, the ultrasound probe 20 is inserted into the resin tube 32 from the aperture 31c of the joint 31 in the direction of the distal end of the resin tube 32.

Then, water is supplied from the water supply nozzle 6. The water flows through the resin tube 42, and enters the joint 41. The water is then branched to each of the resin tubes 33 through the apertures 41a and 41b. Afterwards, the same operations as in the second mode for embodying the invention are performed.

In FIG. 9, the tridental joint 41 is used, but it is also possible to use a joint having more inlets (having a plurality of inlets), and the ultrasound probe cleaning tube 30 shown in FIG. 8 can be provided for each aperture. Thus, the plurality of ultrasound probes can be simultaneously cleaned only by exchange the joints.

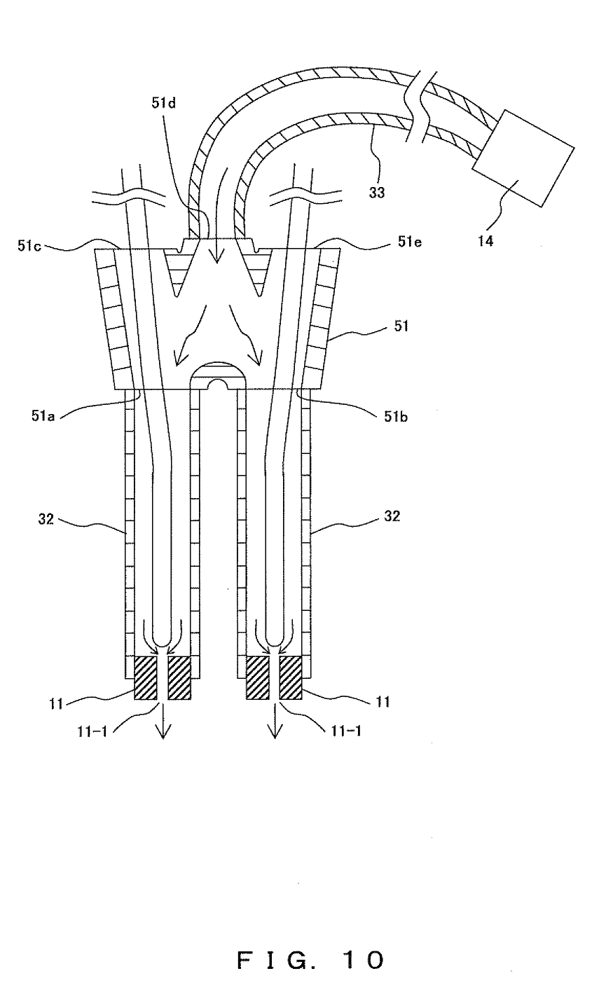

FIG. 10 shows the state of providing a plurality of ultrasound probe cleaning tubes for one water supply nozzle attachment according to the second embodiment of the present mode for embodying the invention. In FIG. 10, the resin tube 32 is extended from each of apertures 51a and 51b of a quintuple joint 51, and the draining member 11 is attached at the distal end of each resin tube 32. The resin tube 33 extends also from an aperture 51d, and the water supply nozzle attachment 14 is attached at the distal end of the resin tube 33.

First, the water supply nozzle attachment 14 is connected and fixed to the water supply nozzle 6. The ultrasound probe 20 is inserted into the resin tube 32 from the apertures 51c and 51e of the joint 51 in the direction of the distal end of the resin tube 32.

Then, water is supplied from the water supply nozzle 6. The water flows through the resin tube 33, and enters the joint 51. The water is then branched to each of the resin tubes 32 through the apertures 51a and 51b. Afterwards, the same operations as in the second mode for embodying the invention are performed.

In FIG. 10, the quintuple joint 51 is used, but it is also possible to use a joint having more inlets (having a plurality of inlets), and the resin tube 32 having the draining member 11 can be provided for each aperture. Thus, the plurality of ultrasound probes can be simultaneously cleaned only by exchange the joints.

According to the present mode for embodying the invention, the water discharged from one water supply nozzle 6 can be branched into a plurality of ultrasound probe cleaning tubes. Therefore, a plurality of ultrasound probes can be simultaneously reprocessed in one reprocessing procedure.

In each of the modes for embodying the invention described above, variations can be realized within the gist of the present invention.

According to the present invention, the cleaning effect can be improved on the microstructures around the distal end of the ultrasound probe without destroying the function of the ultrasound transducer when the ultrasound probe is cleaned.

What is claimed is:

1. A probe cleaning tube which cleans a probe in a cleaning tub of an endoscope reprocessor having a water supply nozzle for supplying liquid for reprocess, the probe cleaning tube being made of at least a soft resin tube, and comprising:
an aperture made in a side of the soft resin tube, and having a diameter larger than an outer diameter of the probe;
a water supply nozzle attachment provided at one end of the soft resin tube for coupling and removing to the water supply nozzle; and
a drain unit having a drain port at another end of the soft resin tube to stop passage of the probe.

2. The probe cleaning tube according to claim 1, wherein
the probe is an ultrasound probe.

3. The probe cleaning tube according to claim 1, wherein
the soft resin tube is a silicon tube or a vinyl chloride tube.

4. A probe cleaning tube which cleans a probe in a cleaning tub of an endoscope reprocessor having a water supply nozzle for supplying liquid for reprocess, the probe cleaning tube being made of at least a plurality of soft resin tube and one or more joints having three or more outlets, one end of the first soft resin tube being coupled to a first outlet of the joint, and the probe cleaning tube comprising:
a drain unit having a drain port at another end of the soft resin tube to stop passage of the probe;
the probe configured to be inserted toward the drain unit of the first soft resin tube from a second outlet corresponding to the first outlet in the joint outlets; and
a water supply nozzle attachment for coupling and removing to the water supply nozzle at a distal end of a second soft resin tube to which a third outlet of the joint is coupled.

5. The probe cleaning tube according to claim 4, wherein
the probe is an ultrasound probe.

6. The probe cleaning tube according to claim 4, wherein
the soft resin tube is a silicon tube or a vinyl chloride tube.

7. The probe cleaning tube according to claim 4, wherein
the water supply nozzle attachment is replaced with the second joint coupled to the distal end of the second soft resin tube, and the probe cleaning tube is provided at a fourth inlet of the second joint; and
a third soft resin tube is coupled to a fifth inlet of the second joint, and the water supply nozzle attachment is provided at a distal end of the third soft resin tube.

8. The probe cleaning tube according to claim 7, wherein
the probe is an ultrasound probe.

9. The probe cleaning tube according to claim 7, wherein
the soft resin tube is a silicon tube or a vinyl chloride tube.
